(19) United States
(12) Patent Application Publication
(10) Pub. No.: US 2024/0218585 A1
(43) Pub. Date: Jul. 4, 2024

(54) MOBILE HOME CLOTHES DRYING ASSEMBLY

(71) Applicant: Grahame Frank William PILGRIM, Scarborough (AU)

(72) Inventor: Grahame Frank William PILGRIM, Scarborough (AU)

(21) Appl. No.: 18/289,113

(22) PCT Filed: May 5, 2022
(86) PCT No.: PCT/AU2022/050423

§ 371 Date: Oct. 31, 2023

(30) Foreign Application Priority Data
May 6, 2021 (AU) 2021901353
Feb. 4, 2022 (AU) 2022900220

(51) Int. Cl. D06F 53/04; B60P 3/36; B60R 15/02; D06F 53/02; E04H 15/08

(52) U.S. Cl. CPC D06F 53/04; B60P 3/36; B60R 15/02; D06F 53/02; E04H 15/08

(57) ABSTRACT

A mobile home clothes drying assembly has line-support arms that are configured to attach to an awning roller tube. Each line support arm has an elongate portion for supporting lines of the mobile home clothes drying assembly and an attachment arrangement that extends from an end of the elongate portion and which is configured to attach to the awning roller tube. The attachment arrangement may include an angular stop member extending away from the elongate portion and dimensioned to be received within a sail track of the awning roller tube. One or more lines are provided that are extendible between adjacent line-support arms for hanging articles to be dried.

### RELATED APPLICATIONS

Priority is claimed from Australian provisional patent application No. 2021901353, filed 6 May 2021 and from Australian provisional patent application No. 2022900220 filed 4 Feb. 2022, the content of each is incorporated herein by reference.

### TECHNICAL FIELD

The present invention relates to an assembly for hanging washed clothes for drying that is particularly adapted to be used with mobile homes such as camper vans and caravans that have an awning.

### BACKGROUND

Any references to methods, apparatus or documents of the prior art are not to be taken as constituting any evidence or admission that they formed, or form part of the common general knowledge.

Travelling with a mobile home, such as a caravan or motorhome is a very popular pastime.

In order to provide additional undercover space at a campsite it is known to provide a canopy or rollout awning for a mobile home. A clothesline for drying washed clothing may be set up under the awning.

For example, FIGS. 1 and 2 are views of a front end and right-hand side, of a mobile home in the form of a caravan 1.

Telescopic awning support arms 3 are pivotally mounted by hinges 5 to the side of the caravan 1 toward its forward and rear ends.

An awning roller tube 7, which is typically spring loaded, is attached between upper ends of the awning support arms 3 for supporting an outer edge of awning canopy 11.

The awning support arms 3 are extended with their upper ends supporting the awning roller tube 7. The awning canopy 11 extends from an awning track (not shown) along the side of the caravan 1 to the awning roller tube 7. A bead is formed along a remote border portion of the awning canopy and the bead is captured in a longitudinal sail track 13 (visible in FIG. 9) of the awning roller tube 7. Left and right tension struts 15 attach proximally towards an upper edge of the side of the caravan and distally to the remote ends of the left and right awning support arms 3. The triangulation of the caravan side wall, tension struts 15 and awning support arms 3 provides support to the awning roller tube 7 and thus the awning canopy 11 as shown in FIGS. 1 and 2.

When the caravan 1 is parked the awning canopy 11 can be extended laterally from a side of caravan 1 to provide shade and an undercover outside area. It is known to set up portable washing lines or drying racks under the awning canopy 11, however such arrangements take up valuable space in the undercover outside area.

Alternatively, as illustrated in FIGS. 3 and 4, it has been known to string at least one line 17 between the awning support arms 3 from which to hang articles 19 to be dried. However, in order to string the at least one line 17 between the awning support arms 3 it is typically necessary to drill holes through the support arms or rivet or otherwise attach fasteners to the support arms to which ends of the lines can be fastened. Such operations damage the awning support arms 3, which are typically of powder coated steel and thus prone to corrosion, if dealt with in such a way.

It would be desirable if a mobile home clothes drying assembly were provided that is simple to use and which does not require modification of the support arms of the awning assembly.

It is an object of the present invention to provide such a mobile home clothes drying assembly.

### SUMMARY OF THE INVENTION

According to a first aspect of the present invention there is provided a line-support arm for a mobile home clothes drying assembly configured to be attached to an awning roller tube, the line-support arm comprising an elongate portion for supporting lines of the mobile home clothes drying assembly; and an attachment arrangement extending from an end of the elongate portion and configured to attach to the awning roller tube.

In an embodiment the line-support arm includes an angular stop member extending away from the elongate portion and dimensioned to be received within a sail track of the awning roller tube.

In an embodiment the elongate portion is comprised of a first elongate member and a second elongate member pivotally connected to each other.

In an embodiment the attachment arrangement extends from an end of the elongate portion.

In an embodiment the attachment arrangement comprises a first clamping member fast with the elongate portion and a second clamping member arranged to cooperate with the first clamping member to clamp the awning tube therebetween.

In an embodiment an upper end of the first clamping member is attached to an upper end of the second clamping member by a hinge.

In an embodiment an end of the second clamping member remote from the hinge is engageable with the elongate portion for clamping the first and second clamping members about the awning tube.

In an embodiment an anti-tilt member is spaced from the attachment arrangement for opposing tilting of the line-support arm in use.

In an embodiment the line-support arm includes an extension arm formed with openings therethrough for passage of an end of the elongate portion of the line-support arm.

In an embodiment the extension arm includes bolt holes for passage of a bolt or other elongate fastening member for fastening of the extension arm to the elongate portion.

In an embodiment the line-support arm includes a post tube for receiving an end of a post for stabilizing the assembly.

In an embodiment the line-support arm includes a tether point attached to the elongate portion for attachment of a line thereto.

In an embodiment the attachment arrangement includes a hook for attachment of a line thereto.

In an embodiment the attachment arrangement includes a spring member extending from the elongate portion for placement about the awning roller tube to thereby bias the angular stop member toward the awning roller tube.

In an embodiment the spring member is arcuate for placement about a portion of the awning roller tube.

In an embodiment the angular stop member comprises a tongue that extends from an end of the elongate portion.

In an embodiment the attachment arrangement includes at least one retaining hook configured to extend through the awning roller tube in use.

In an embodiment the at least one retaining hook extends from an arcuate surface that extends from the end of the elongate portion.

In an embodiment one or more holes are formed through the elongate portion for passage of portions of each of the one or more lines.

In an embodiment the line-support arm includes bushes that are received in the one or more holes.

In an embodiment the elongate portion comprises a length of square steel section.

In an embodiment a plug fills an end of the length of square steel section.

In an embodiment the length of square steel section is 316 marine grade stainless steel.

In an embodiment the line-support arm includes an axial stop for preventing sliding of the first line-support arm and the second line-support arm along the awning roller tube.

In an embodiment the axial stop comprises a pin that is fast with the elongate portion for extending into an opening formed in the awning roller tube.

In an embodiment the axial stop is fastened to the elongate portion by a transverse member.

In an embodiment the transverse member comprises a gusset.

In an embodiment the line-support arm includes an extension member for attachment to the elongate portion.

In an embodiment an end portion of the extension member is pivotally connectable to the line-support arms by means of a pivot arrangement.

In an embodiment the line-support arm includes a first clamping member fast with the end portion of the extension member and a second clamping member fast with the end portion of the elongate portion of the line-support arm.

In an embodiment the first clamping member has a first central opening with a first set of radial serrations extending therefrom and the second clamping member has a second central opening with a second set of radial serrations extending therefrom, wherein the second set of radial serrations complement the first set of radial serrations.

In an embodiment a threaded member extends through the first central opening and the second central opening.

In an embodiment one end of the threaded member locates outside the extension member and an opposite end of the threaded rod locates outside the elongate portion of the line-support arm.

In an embodiment one end of the threaded rod is fitted with a tightening “knob” or handle.

In an embodiment an end of the threaded rod opposite the handle is threadedly engaged by a threaded member whereby operating the tightening knob draws the first set of radial serrations and the second set of radial serrations into abutment for retaining the extension member and the elongate portion of the line-support arm at a desired angle.

According to a further aspect of the present invention there is provided a mobile home clothes drying assembly comprising:
a plurality of line-support arms configured to attach to an awning roller tube;
one or more lines extendible between adjacent line-support arms of the plurality of line-support arms, for hanging articles to be dried therefrom,
wherein each of the plurality of line-support arms includes:
   an elongate portion for supporting the lines; and
   an attachment arrangement extending from an end of the elongate portion and configured to attach to the awning roller tube.

In an embodiment each of the plurality of line support arms comprises a line-support arm including one or more of the features previously summarised.

According to one aspect of the present invention there is provided a mobile home clothes drying assembly comprising:
a plurality of line-support arms configured to attach to an awning roller tube;
one or more lines extendible between adjacent line-support arms of the plurality of line-support arms, for hanging articles to be dried therefrom,
wherein each of the plurality of line-support arms includes:
   an elongate portion for supporting the lines; and
   an attachment arrangement extending from an end of the elongate portion and configured to attach to the awning roller tube.

In an embodiment the attachment arrangement comprises a first clamping member fast with the elongate portion and a second clamping member arranged to cooperate with the first clamping member to clamp the awning tube therebetween.

In an embodiment the mobile home clothes drying assembly includes an angular stop member extending from the elongate portion and dimensioned to be received within a sail track of the awning roller tube.

In an embodiment the elongate portion is comprised of a first elongate member and a second elongate member pivotally connected to each other.

In an embodiment the attachment arrangement extends from an end of the first elongate member.

In an embodiment an upper end of the first clamping member is hingedly attached to an upper end of the second clamping member.

In an embodiment an end of the second clamping member remote from the hinge is engageable with the elongate portion fixing the first and second clamping members about the awning tube.

In an embodiment an anti-tilt member is spaced from the attachment arrangement for opposing tilting of the line-support arm in use.

In an embodiment there is provided an extension arm formed with openings therethrough for passage of an end of the elongate portion of the line-support arm.

In an embodiment the extension arm includes bolt holes for passage of a bolt or other elongate fastening member for fastening of the extension arm to the end of the elongate portion.

In an embodiment the attachment arrangement includes a spring member extending from the elongate portion for placement about the awning roller tube to thereby bias the angular stop member toward the awning roller tube.

In an embodiment the spring member is arcuate for placement about a portion of the awning roller tube.

In an embodiment a remote end portion of the spring member is formed as a return for attachment of a tether line thereto.

In an embodiment the angular stop member comprises a tongue that extends from an end of the elongate portion.

In an embodiment the attachment arrangement includes at least one retaining hook configured to extend through the awning roller tubein use.

In an embodiment the at least one retaining hook extends from an arcuate surface that extends from the end of the elongate portion.

In an embodiment one or more holes are formed through the elongate portion for passage of portions of each of the one or more lines.

In an embodiment the elongate portion 23 includes bushes 27 that are received in the one or more holes.

In an embodiment the elongate portion comprises a length of square steel section.

In an embodiment a plug fills an end of the length of square steel section.

In an embodiment the length of square steel section is 316 marine grade stainless steel.

In an embodiment the one or more line-support arms comprises a first line-support arm and a second line-support arm, wherein at least one of the first line-support arm and the second line-support arm includes an axial stop for preventing sliding of the first line-support arm and the second line-support arm along the awning roller tube.

In an embodiment the axial stop comprises a pin that is fast with the elongate portion for extending into an opening formed in the awning roller tube.

In an embodiment the axial stop is fastened to the elongate portion by a transverse member.

In an embodiment the transverse member comprises a gusset.

In an embodiment the mobile home clothes drying assembly includes one or more extension members for attachment to respective ones of the plurality of line-support arms.

In an embodiment end portions of each of the one or more extension members are pivotally connectable to the line-support arms by means of a pivot arrangement.

In an embodiment the pivot arrangement includes a first clamping member fast with the end portion of the extension member and a second clamping member fast with the end portion of the elongate portion of the line-support arm.

In an embodiment first clamping member has a first central opening with a first set of radial serrations extending therefrom and the second clamping member has a second central opening with a second set of radial serrations extending therefrom, wherein the second set of radial serrations complement the first set of radial serrations.

In an embodiment a threaded member extends through the first central opening and the second central opening.

In an embodiment one end of the threaded member locates outside the extension member and an opposite end of the threaded rod locates outside the elongate portion of the line-support arm.

In an embodiment one end 90 of the threaded rod 89 is fitted with a tightening “knob” or handle.

In an embodiment an opposite end of the threaded rod is threadedly engaged by a threaded member whereby operating the tightening knob draws the first set of radial serrations and the second set of radial serrations into abutment for retaining the extension member and the elongate portion of the line-support arm at a desired angle.

According to another aspect of the present invention there is provided a mobile home clothes drying assembly comprising a plurality of line-support arms configured to attach to an awning roller tube and one or more lines extendible between adjacent line-support arms of the plurality of line-support arms, for hanging articles to be dried therefrom.

According to a further aspect of the invention there is provided a line support arm configured to attach to an awning roller tube and to support a portion of a line for hanging articles to be dried therefrom.

According to another aspect of the invention there is provided a mobile home clothes drying assembly including a plurality of line-support arms for supporting lines for hanging articles to be dried therefrom, wherein each of the line-support arms is comprised of a combination of features from any of the embodiments described herein and wherein such a combination may comprise fewer features than are present in the preferred embodiments that are described with reference to the Figures.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an end view of a prior art mobile home in the form of a caravan.

FIG. 2 is a side view of the caravan of FIG. 1.

FIG. 3 is an end view of the caravan of FIG. 1 with a prior art clothes drying line hung between arms of an awning of the caravan.

FIG. 4 is a side view of the caravan of FIG. 1 with a prior art clothes drying line hung between arms of an awning of the caravan.

FIG. 5 depicts a mobile home clothes drying assembly according to an embodiment of the present invention.

FIG. 6 is a front view of a first line-support arm of the clothes drying assembly.

FIG. 7 is a side view of the first line-support arm of the clothes drying assembly.

FIG. 8 is a rear view of the first line-support arm of the clothes drying assembly.

FIG. 9 is a side view of the first line-support arm of the clothes drying assembly shown fitted to an awning roller tube.

FIG. 10 is a side view of a further line-support arm of clothes drying assembly according to an embodiment of the invention.

FIG. 11 is a front view of the line-support arm of FIG. 10.

FIG. 12 is a side view of the line-support arm of FIG. 10, shown fitted to an awning roller tube.

FIG. 13 is a rear view of a line-support arm according to an embodiment of the present invention.

FIG. 14 is a side view of the line-support arm of FIG. 13.

FIG. 15 is a front view of the line-support arm of FIG. 13.

FIG. 16 is a side view of the line support arm of FIG. 13, shown fitted to an awning roller tube.

FIG. 17 is a side view of the line-support arm of FIG. 9 in a typical orientation for use.

FIG. 18 is a side view of the line-support arm of FIG. 16 in a typical orientation for use.

FIG. 19 is a side view of the line-support arm of FIG. 9 in a typical orientation use and shown mounted to a awning roller arm.

FIG. 20A is a side view of a line-support arm according to an embodiment of the present invention that is adapted for use with an extension member.

FIG. 20B is a side view of an extension member according to an embodiment of the invention.

FIG. 21 is a partially exploded side view of the line-support arm of FIG. 20A and the extension member of FIG. 20B.

FIG. 22 is a side view of the line-support arm of FIG. 20A fastened to the extension member of FIG. 20B at an acute angle.

FIG. 23 is a side view of a mobile home clothes drying assembly, shown in use, according to an embodiment of the present invention which includes the extension members.

FIG. 24 is an end view of a mobile home clothes drying assembly, shown in use, according to an embodiment of the present invention which includes the extension members.

FIG. 25 depicts a mobile home clothes drying assembly according to a further embodiment of the present invention.

FIG. 26 is a view of a line-support arm for the mobile home clothes drying assembly according to an embodiment of the present invention.

FIG. 27 is a further view of the line support arm.

FIG. 28 is a view of the line support arm of wherein first and second elongate members comprising an elongate portion of the line-support arm have been pivoted relative to each.

FIG. 29 is a view of the line support arm prior to installation of the line support arm about an awning tube.

FIG. 30 is a view of the line support arm shown installed about the awning tube.

FIG. 31 is a view of an extension arm.

FIG. 32 is a view of a line-support arm including the extension arm.

FIG. 33 is a view in the direction of arrow “A” of FIG. 33 with a facing wall of the second elongate member 23-2 removed to show internal fastening of the extension arm to the second elongate member 23-2.

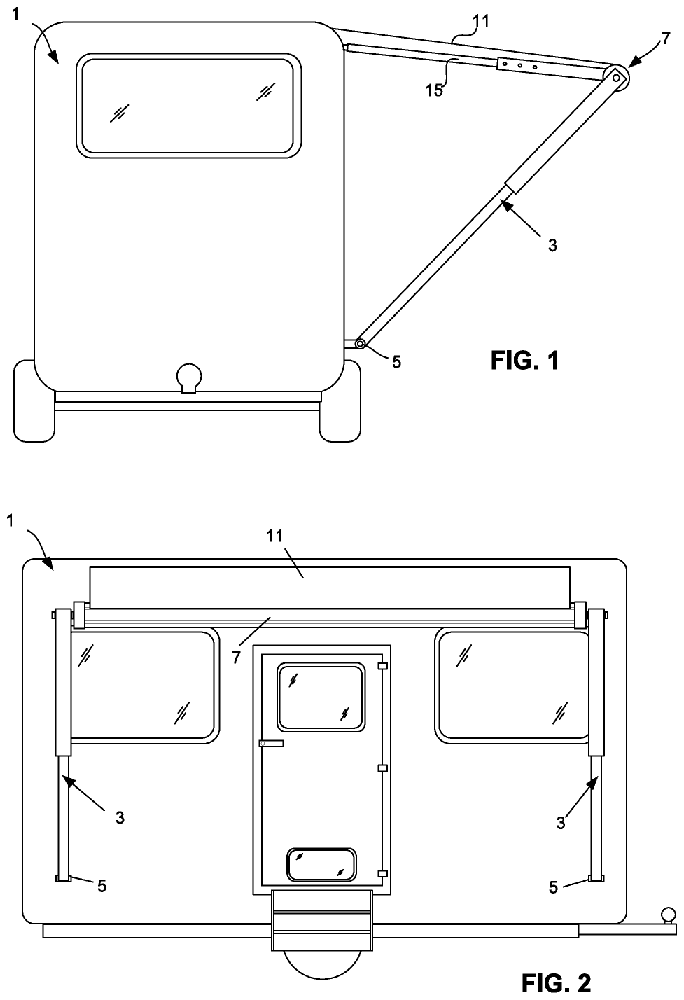

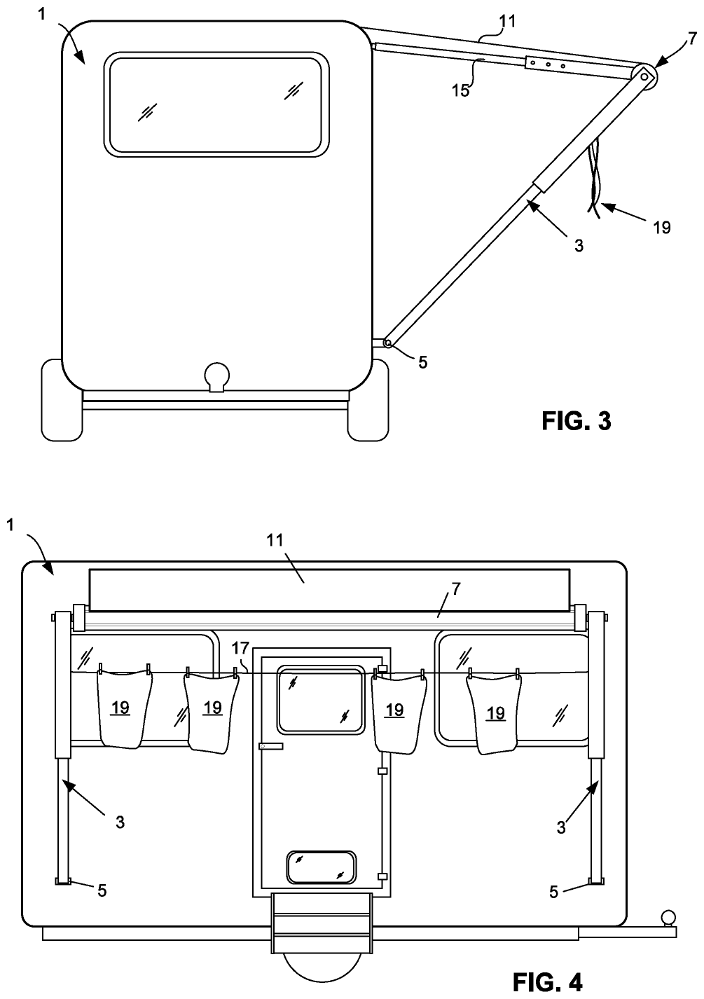

### DETAILED DESCRIPTION OF PREFERRED EMBODIMENTS

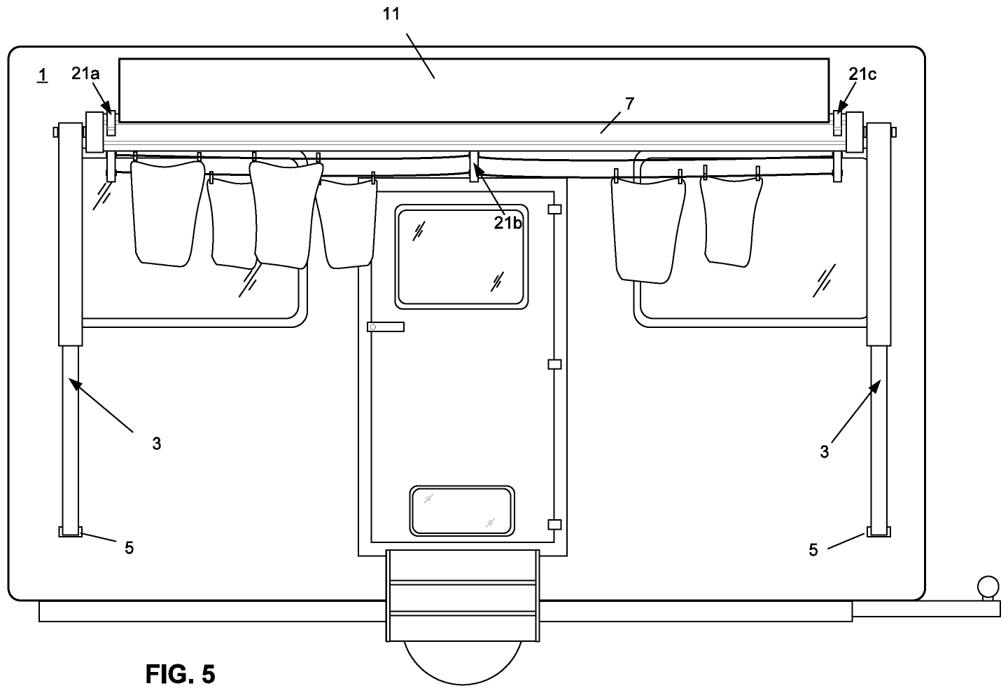

FIG. 5 depicts a mobile home clothes drying assembly shown in use and comprising, in this example, three line-support arms 21a, 21b and 21c. In the present example, line-support arms 21a, 21c are identical whereas line-support arm 21b is a variation thereof.

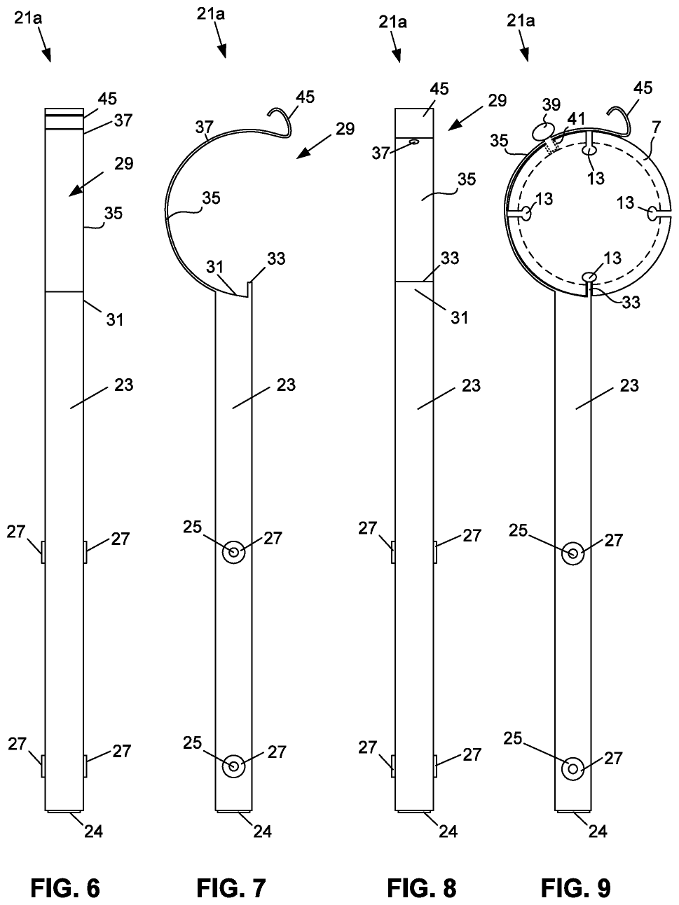

Each of the three line-support arms 21a, 21b and 21c are configured to attach to awning roller tube 7 as will be described. It will be realized that in other embodiments more than three, or only two, line-support arms may be present. FIG. 6 is a view of a rear of line-support arm 21a according to an embodiment. FIG. 7 is a side view of the line-support arm 21a and FIG. 8 is a front view of the line-support arm 21a.

The line-support arm 21a includes an elongate portion 23, which is formed with a number of holes 25 therethrough for supporting lines. In use, ends of the lines are threaded through the holes 25 and tied thereto or knotted on a remote side of the hole so that the knotted portion cannot be withdrawn. In other embodiments brackets may be fastened to the elongate portion for supporting the lines by tying thereto rather than by means of the holes 25.

Each of the holes is lined with opposed plastic bushes 27 for preventing wear of the lines.

In an embodiment the elongate portion 23 comprises a length of square steel section, which is preferably 316 marine grade stainless steel. A plug 24 is provided that plugs, and covers off, a lower end of the elongate portion 23.

An attachment arrangement 29 extends from an upper end 31 of the elongate portion 23 and is configured to attach to the awning roller tube 7 as will be explained.

The attachment arrangement includes an angular stop member 33, which extends from the upper end 31 of the elongate portion 23. The angular stop member 33 may comprise a tongue and is dimensioned to be received within a sail track 13 (shown in FIG. 8) of the awning roller tube 7. Once installed in the sail track 13 the angular stop member 33 acts to resist angular, such as pivoting, motion of the support arm 21 about the awning roller tube 7 due to its insertion into the sail track 13.

The attachment arrangement includes a spring member 35 that extends from an upper end 31 of the elongate portion 23 for placement about the awning roller tube 7 for biasing the angular stop member toward the awning roller tube.

Spring member 35 is arcuate with a resting radius that is preferably a little smaller than the radius of the awning roller tube 7 so that the spring member 35 holds onto the awning roller tube 7 once it has been placed thereabout.

A remote end portion of the spring member 35 may be formed as a return 45 that is preferably arcuate and which is suitable for attachment of a tether line thereto. The tether line may extend to a ground peg and be used to stabilize the awning for example.

Whilst not essential, in the presently described embodiment a hole 37 is formed through the spring member 35 and a grub screw 39 is threaded through the hole 37 and into a corresponding threaded hole 41 formed into the awning roller tube 7. The grub screw 39 acts to provide additional attachment force of the spring member 35 to the awning roller tube 7 and also assists in preventing axial motion of the line-support arm 21a along the awning roller tube 7.

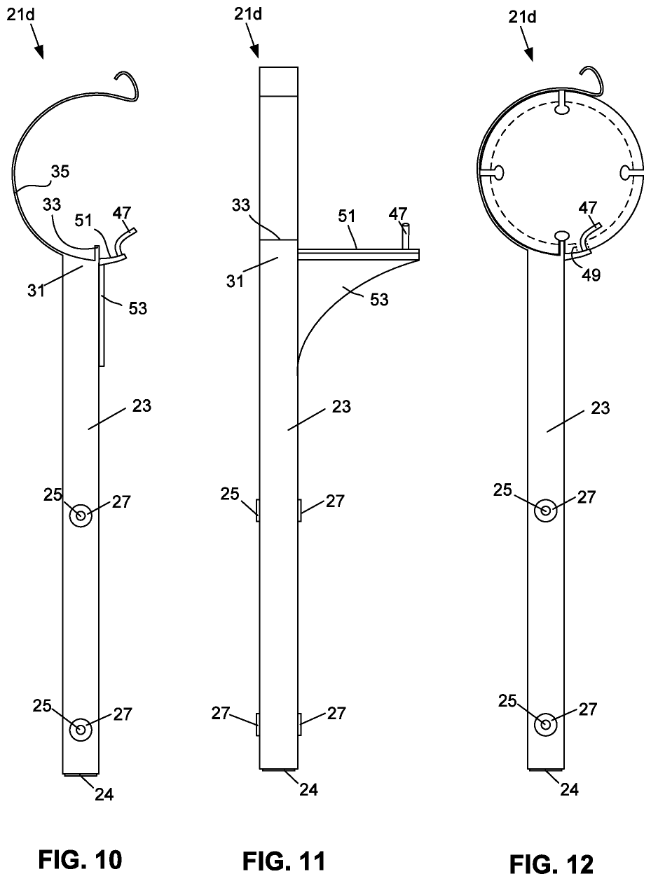

In a further embodiment of the line-support arm, illustrated as item 21d in FIGS. 10 to 12, line-support arm 21 includes an axial stop in the form of a pin 47. The pin 47 is configured for engagement in a hole 49 formed through a side of the awning roller tube 7, as illustrated in FIG. 12, to thereby prevent axial sliding of the line-support arm 21 along the awning roller tube 7.

In an embodiment the pin 47 is fast with the elongate portion 23 and fastened thereto by a transverse member in the form of a gusset 53. The line-support arm 21d may also include a grub screw arrangement such as that which has been described in relation to grub screw 39 of FIG. 9.

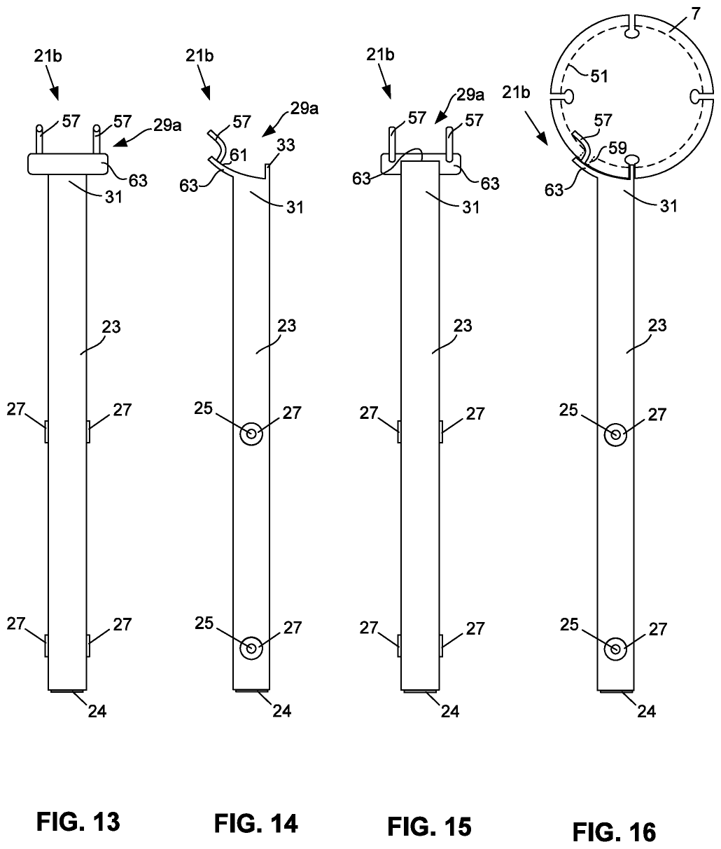

Referring now to FIGS. 13 to 16, line-support arm 21b (as firstly identified in FIG. 5) is illustrated. In the embodiment of line-support arm 21b, the attachment arrangement 29 includes two retaining hooks 57. Retaining hooks 57 extend from an arcuate surface 61 of a transverse member 63 that extends laterally on opposite sides adjacent the upper end 31 of the elongate portion 23 of line-support arm 21b. In use, the retaining hooks 57 extends through corresponding holes 59 formed through the awning roller tube 7 and abut an internal wall 51 of the awning roller tube 7 as shown in FIG. 16 to assist in securing the support arm 21 to the awning roller tube 7 and in preventing axial motion of the support arm 21 axially along the awning roller tube 7.

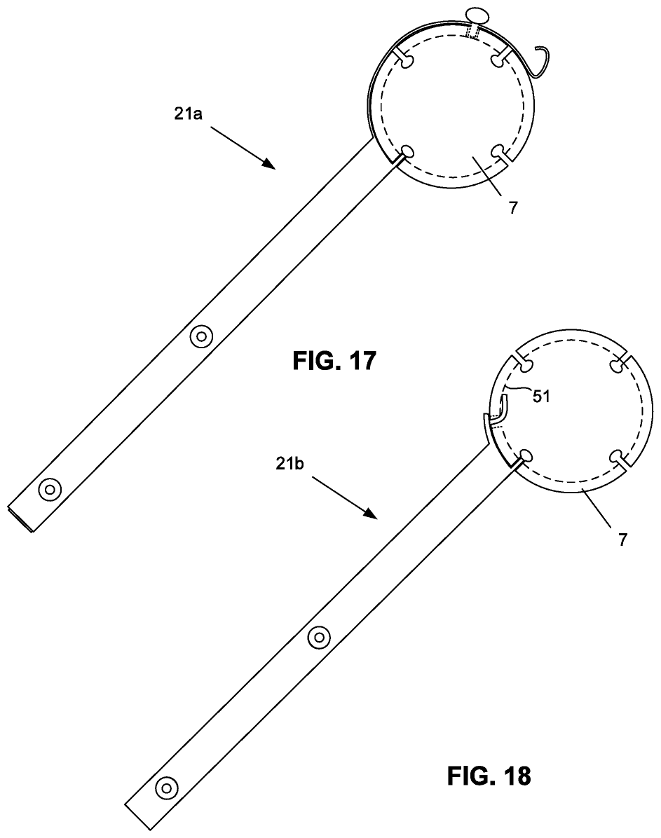

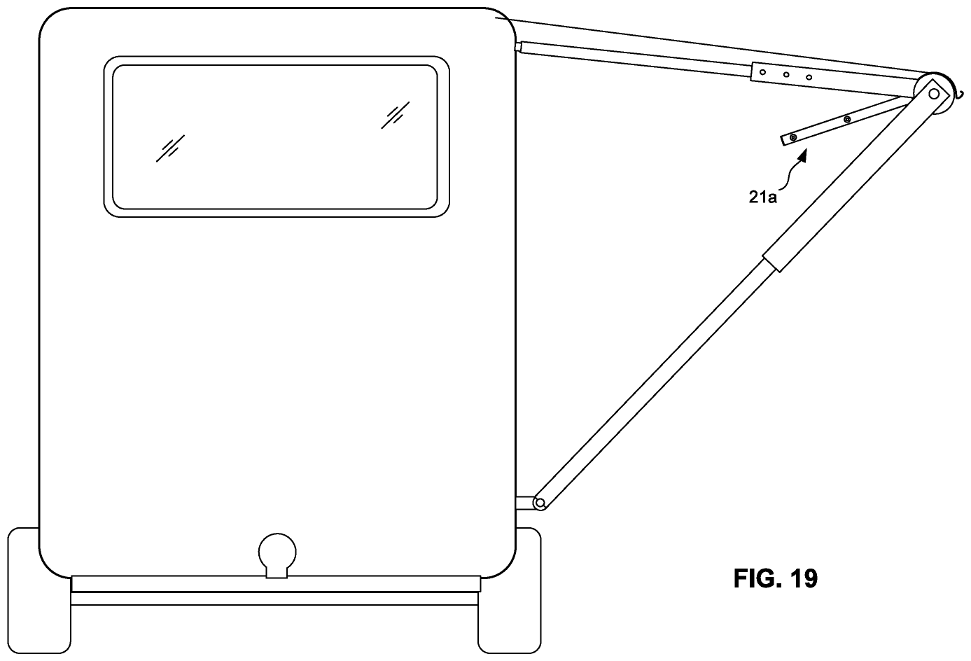

FIGS. 17 to 19 show the line-support-arms 21a and 21b in side profile attached to awning roller tube 7 at a typical angle for use.

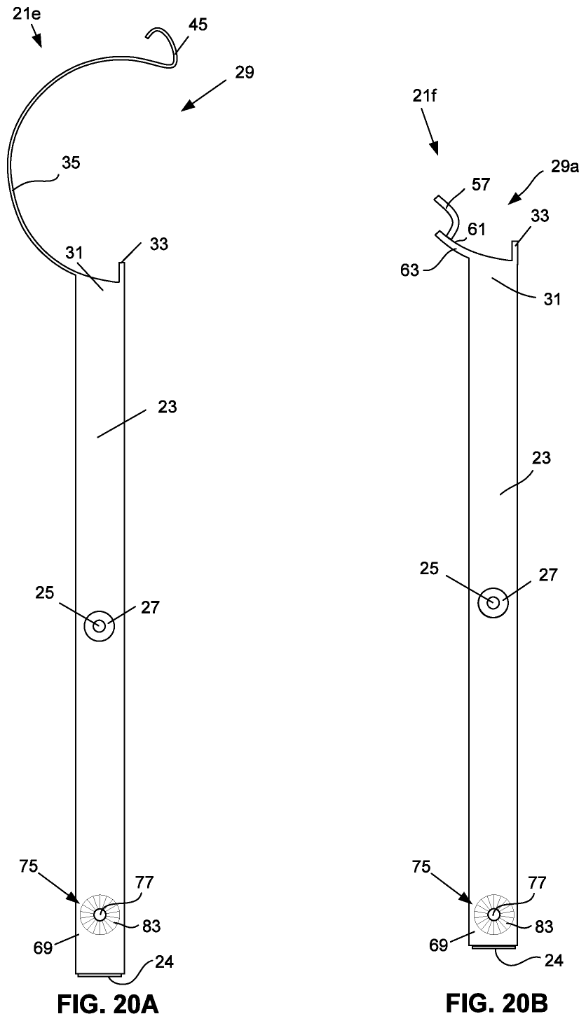

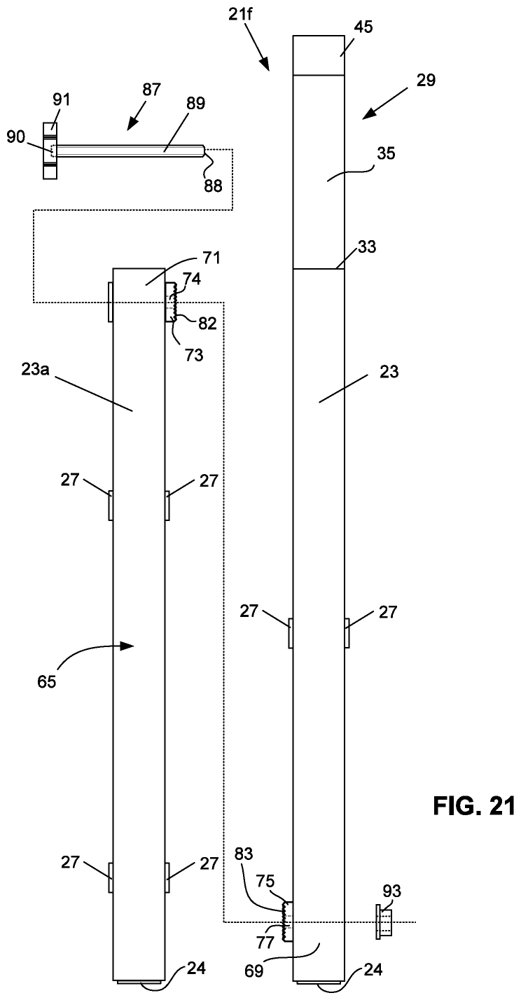

Referring now to FIGS. 20A and 20B, there are shown two line-support arms 21e and 21f in side profile, which are respectively variations of line-support arms 21a and 21b. As will be discussed, line-support arms 21e and 21f are adapted for coupling to an extension member 65, which is illustrated in FIG. 21.

The extension member 65 is pivotally connectable to a lower end portion 69 of the elongate portion 23 of the line-support arms 21e, 21f by means of a pivot arrangement.

In the presently described embodiment the pivot arrangement includes a first clamping member 73 fast with an upper end portion 71 of an elongate member 23a of the extension member 65, and a second clamping member 75 fast with the lower end portion 69 of the elongate member of the line-support arm.

Preferably the first clamping member 73 is circular and has a first central opening 74 with a first set of radial serrations 82 extending therefrom.

Correspondingly, the second clamping member 75 has a second central opening 77 with a second set of radial serrations 83 extending therefrom, The second set of radial serrations 83 complements the first set of radial serrations 82 so that when the first clamping member is forced against the second clamping member, the radial serrations 82, 83 mesh to prevent rotation of one clamping member relative to the other.

As shown in the exploded view of FIG. 21, a pivot member 87 is provided in the form of a threaded rod 89 that extends through the first central opening 74 and the second central opening 77.

End 88 of the threaded rod 89 locates adjacent an outer side of the elongate portion 23 of line-support arm 21f, and an opposite end 90 of the threaded rod 89 locates adjacent an outer side of the elongate member 23a of the line-support arm.

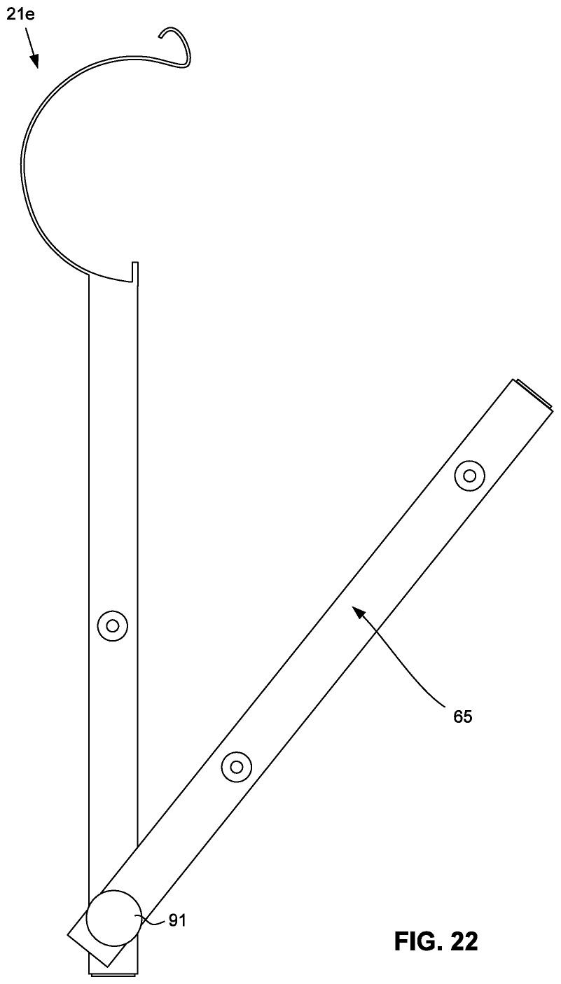

End 90 of the threaded rod 89 is fitted with a tightening knob. End 88 of the threaded rod 89 is threadedly engaged by a threaded member such as bolt 93. Consequently, operating the tightening knob 91 draws the first set of radial serrations 82 and the second set of radial serrations 83 into abutment for retaining the extension member 65 and and the elongate portion 23 of the line-support member 21f at a desired angle. For example, FIG. 22 shows the extension member 65 held at an acute angle to the line-support arm 21e for illustration purposes. In use the extension member 65 is typically held at an obtuse angle to the line-support arm 21e or 21f.

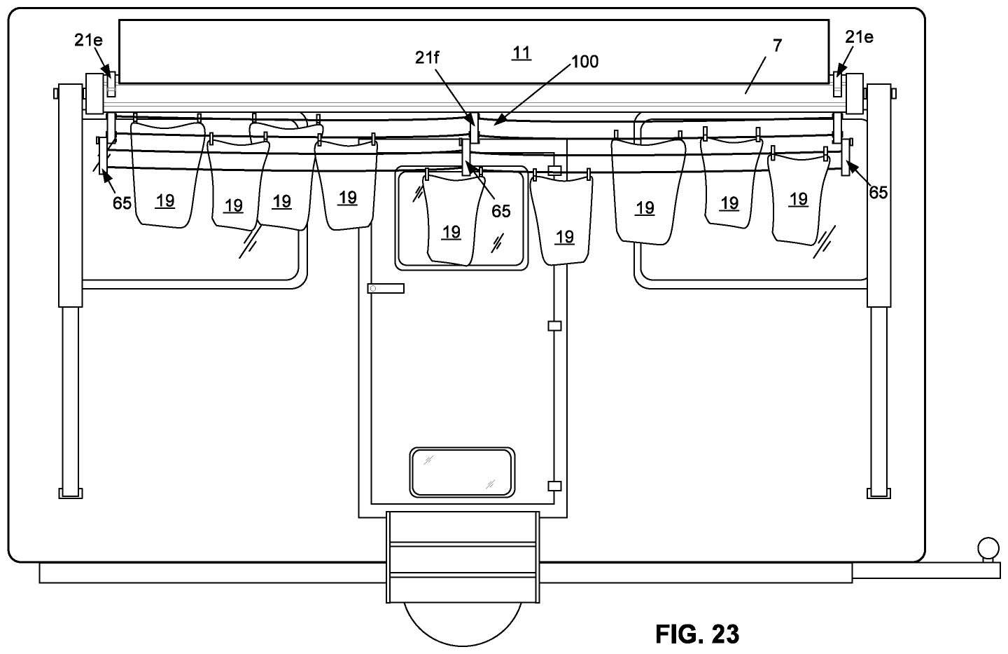

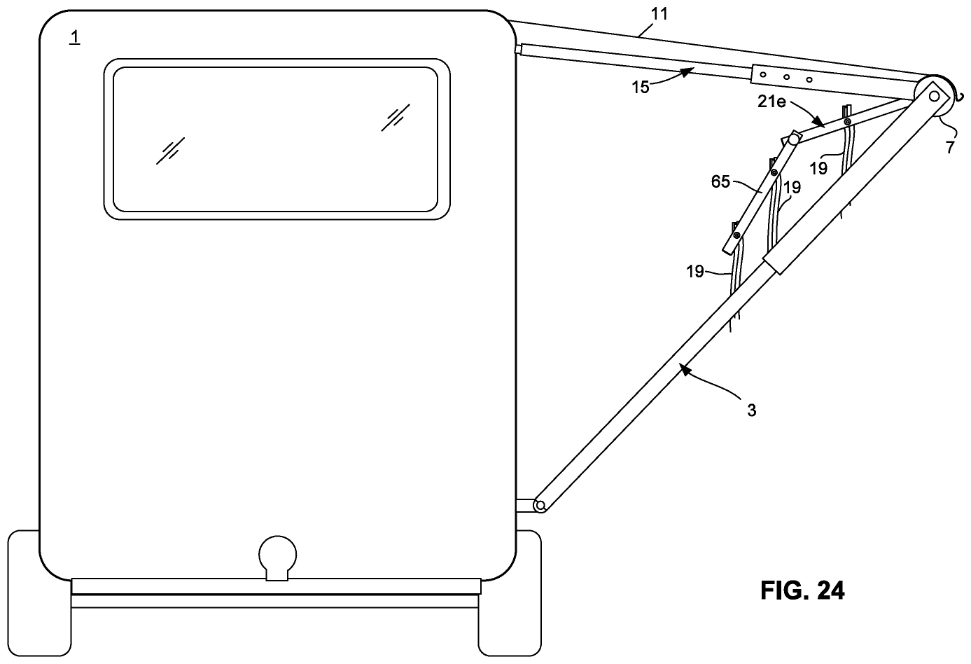

FIGS. 23 and 24 are side and end views of a mobile home clothes drying assembly 100 in use according to an embodiment of the present invention and including the extension members 65.

It will be realized from the foregoing that in an embodiment there is provided a mobile home clothes drying assembly that is comprised of a plurality of line-support arms, which are configured to attach to an awning roller tube and one or more lines extendible between adjacent line-support arms of the plurality of line-support arms, for hanging articles to be dried therefrom.

In some embodiments, for example as illustrated in FIGS. 9 and 10, the line-support arms make use of a spring member 35 which is preferably arcuate and which is configured to be placed around the awning roller tube 7.

The spring member is preferably arcuate and of a radius that is slightly undersized relative to a radius of the awning roller tube so that the spring member holds on to the awning roller tube and which biases a tongue of the line-support arm into an axial sail track of the awning roller tube. Whilst it is preferred that the spring member is arcuate and generally corresponds to a peripheral portion of the awning roller tube, it need not be in all embodiments provided that it is able to bias the tongue into the sail track and hold the line-support arm to the awning roller tube in use. A grub screw may be used to assist in securing the spring member to the awning roller tube. In other embodiments, for example the embodiment illustrated in FIGS. 13 to 16, the one or more line-support arms of the assembly may not include a spring member but may include retaining hooks.

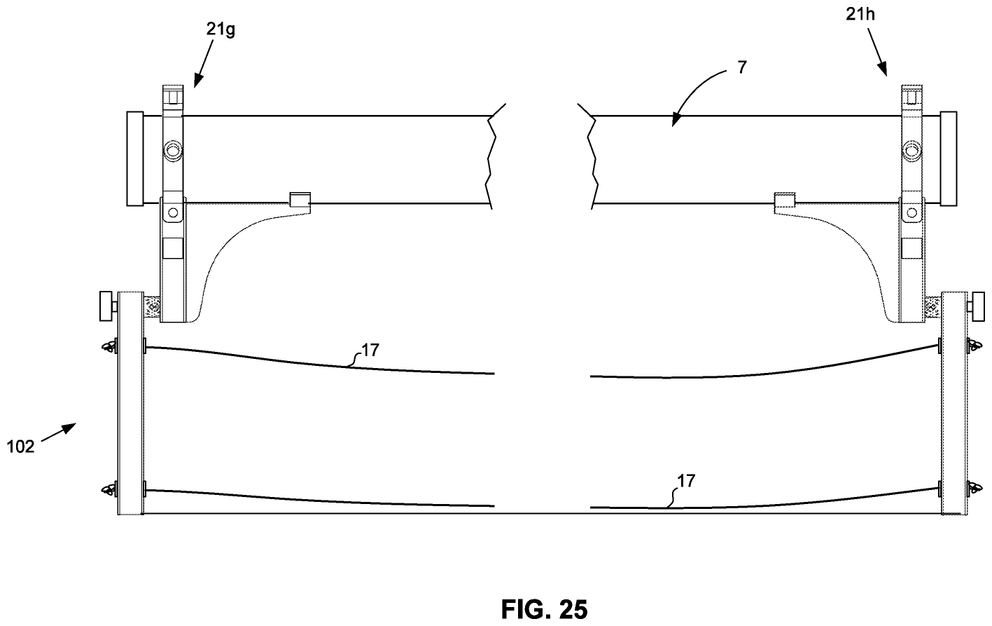

A further embodiment of a mobile home clothes drying assembly 102, shown attached to an awning roller tube 7 is depicted in FIG. 25.

Drying assembly 102 comprises a plurality of line-support arms, in the present example being line-support arms 21g, 21h, which in the present embodiment are mirror images of each other and which are each configured to attach to awning roller tube 7. Lines 17 are extendible between adjacent line-support arms 21g, 21h for hanging articles to be dried therefrom. Although in the presently described embodiment the two line-support members have the same features, in other embodiments of the mobile home clothes drying assembly 102 different embodiments of line-support arms may be used.

Each of the line-support arms 21g, 21h includes an elongate portion for supporting the lines and an attachment arrangement extending from an end of the elongate portion that is configured to attach to the awning roller tube.

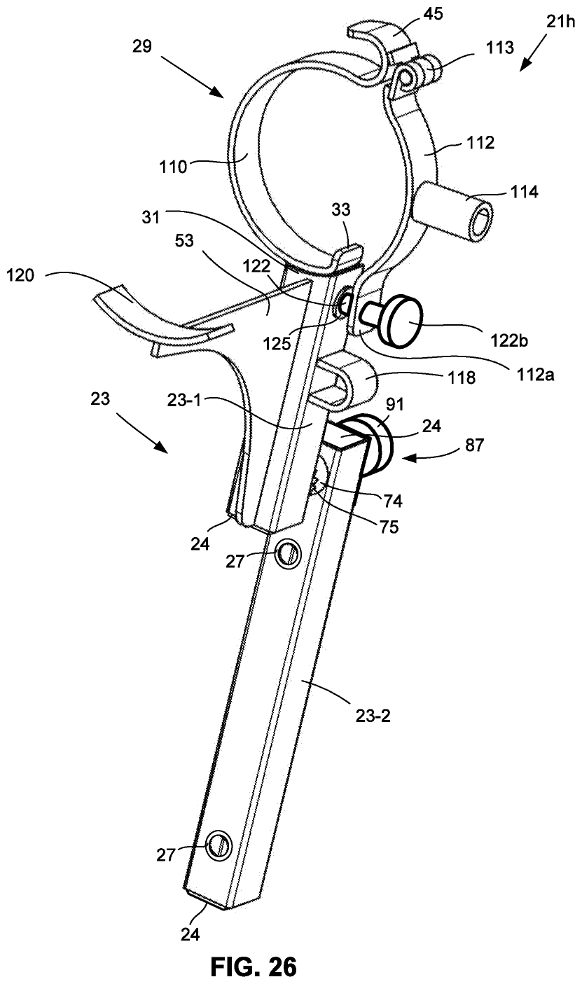

FIG. 26 shows line-support arm 21h in isometric view. Item numbers previously used to describe earlier embodiments will be used to identify similar or corresponding components and assemblies of line-support arm 21h.

In the embodiment of FIG. 25 onward, and as illustrated in FIG. 26 for example, the elongate portion 23 is comprised of first and second elongate members 23-1 and 23-2 which are interconnected by a pivot member 87 that can be operated by a handle 91 to fasten the first and second elongate members 23-1 and 23-2 to each other at a desired angle in similar fashion to the arrangement by which the pivot member 87 of FIG. 21 attaches elongate member 23 of that Figure to extension member 65. In the presently described embodiment the first elongate member 23-1 does not include holes 25 and bushings 27 for the passage of lines though in other embodiments it may.

In an embodiment first and second elongate members 23-1, 23-2 each comprise a length of square steel section, which is preferably 316 marine grade stainless steel. Plugs 24 are provided that plug and cover off ends of each of the elongate members 23-1, 23-2.

An attachment arrangement 29 extends from an upper end 31 of the first elongate member 23-1 of the elongate portion 23. Attachment arrangement 29 is configured to attach to an awning roller tube 7 as will be explained.

Line-support arm 21h includes an attachment arrangement 29 which functions to clamp about the awning tube 7. The attachment arrangement 29 includes an angular stop member 33, which extends from the upper end 31 of the elongate portion 23. The angular stop member 33 may comprise a tongue and is dimensioned to be received within a sail track 13 (shown in FIG. 30) of the awning roller tube 7. Once installed in the sail track 13 the angular stop member 33 acts to resist angular, such as pivoting, motion of the support arm 21h about a longitudinal axis of the awning roller tube 7 due to its insertion into the sail track 13.

The attachment arrangement 29 includes a first clamping member 110 that extends in an arc that generally complements an outer surface of the awning tube 7. The first clamping member 110 extends from the upper end 31 of the elongate portion 23 to describe a semi-circle like profile in the present embodiment. The first clamping member 110 ends in a hook or return 45 that is suitable for tethering a line such as a guy rope thereto. In the presently describe embodiment the angular stop member 33 comprises a lower end portion of the first clamping member, bent to extend away from an upper end of the elongate portion 23 so that it points into the sail track of the awning tube in use. Similarly, the hook 45 is formed by bending an upper end of the first clamping member in an arc through about 180 degrees. It will be realized that the first clamping member 110 can be shaped in ways other than bending, for example by molding or casting of a suitable material.

A second clamping member 112 is provided that is also generally arcuate to complement a portion of an outside of the awning tube and which has an upper end that is connected, adjacent hook 45, to the first clamping member by a hinge 113. Accordingly, the second clamping member 112 may be pivoted to, and away, from the first clamping member 110 about hinge 113. Opposed portions of inner sides of the first clamping member 110 and the second clamping member 112 are preferably lined with a layer of elastomeric material 124 such as synthetic rubber to provide cushioning and gripping between the awning tube 7 and the first and second clamping members 110, 112.

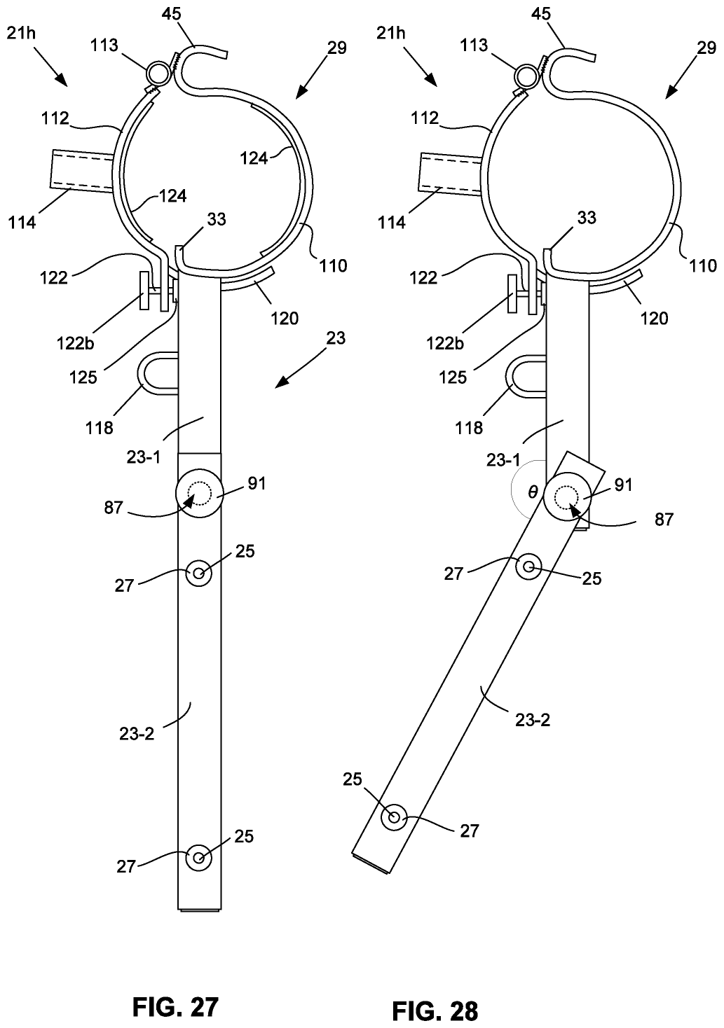

Depending on the degree of clamping force applied by the clamping members 110, 112 to the awning tube via the elastomeric material 24, it may be unnecessary for the angular stop member 33 to be present to prevent turning of the line-support arm about the awning tube. The elastomeric material 124 is shown in FIG. 27 but omitted from the other drawings for clarity.

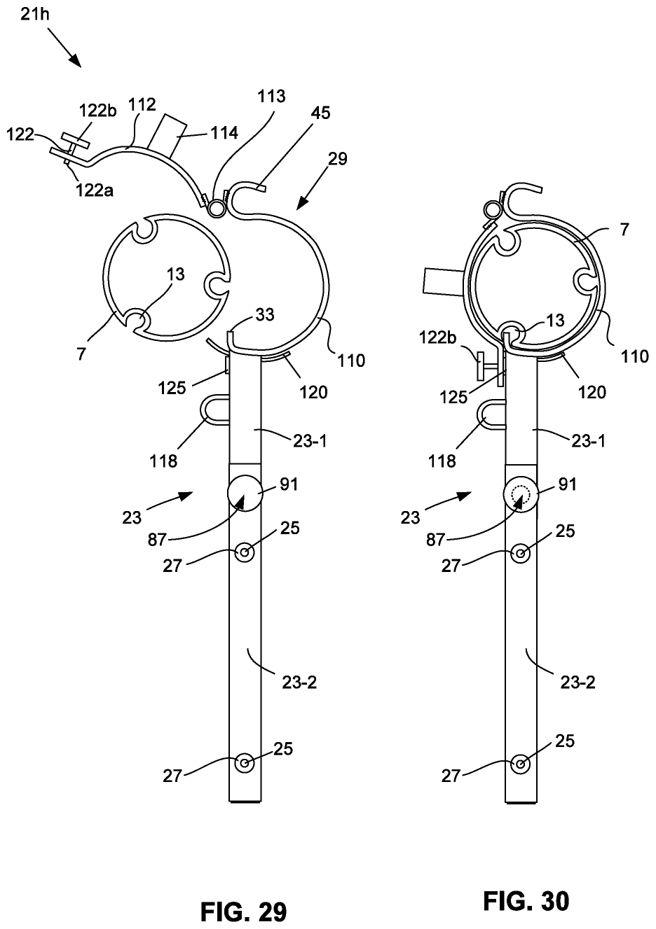

A lower end of the second clamping member 112 is formed as a flat 112a. A fastening bolt 122 (or threaded rod) is provided which extends through the flat 112a and which has a point 122a (FIG. 29) that may be threadedly engaged by a nut 125 that is fastened into a side of the first elongate member 23-1. An end of the fastening bolt 122 opposite point 122a terminates in a clamping handle 122b. Accordingly, by rotating the handle 122b in a first direction the bolt 122 may be engaged with bolt 125 and the second clamping member 112 pivoted about hinge 113 so that it is brought closer to the first clamping member so that the awning tube may be firmly clamped between the first clamping member 110 and the second clamping member 112. Alternatively, rotating the handle 122b in a second direction unscrews the point 122a of the bolt 122 from the nut 125 so that the second clamping member may then be pivoted away from the first clamping member to allow the awning tube to be placed between the two clamping members or disengaged from them, as shown in FIGS. 29 and 30.

A post tube 114 extends from an outside of the clamping member 112. Post tube 114 is for receiving an end of a post such as a tent pole or the like that extends from the ground, to assist in supporting the awning arm when the line-support arms 21g, 21h are attached thereto. Line-support arm 21h also includes a tethering loop 118 that extends from the elongate portion 23 beneath the attachment arrangement 29 and which is for attachment of a line such as a guy rope thereto, to assist in stabilizing the line-support arm 21h in use.

In the presently described embodiment, though not necessarily in all embodiments, the line-support arm 21 includes an anti-tilt member in the form of an arcuate support plate 120. Arcuate support plate 120 is fastened to the elongate member by a transverse member in the form of a gusset 53 and is located a distance L from the first and second clamping members 110, 112 which is an axial distance along the awning tube 7 in use. Consequently, the arcuate support plate 120 operates to resist a tendency of the bottom ends of the support arms 21g and 21h (as shown in FIG. 25) to tilt towards each other due to the weight of items hung on lines 17 to dry.

FIGS. 27 and 28 are plan side views of the line-support arm 21h, viewed from a side opposite that of FIG. 25. FIG. 28 shows how the second elongate member 23-2 may be fixed at a desired angle such as angle θ by operation of fastening member 87 and serrated clamping members 74, 75.

FIG. 29 is an end view of an awning tube 7 (with end caps removed), just prior to the first and second clamping members 110 and 112 being clamped thereabout. It will be observed that the second clamping member 112 has been pivoted about hinge 113 away from the first clamping member 110 in order to provide access for the first clamping member 110 to be brought against the awning tube 7 whilst fitting the angular stop member 33 into the sail track 13. The second clamping member 112 is then pivoted back about hinge 113 so that the awning tube is captured between the second clamping member 112 and the first clamping member 110. The fastening handle is then turned so that the point 122a of the fastening bolt 122 engages nut 125 thereby bringing the second clamping member 112 toward the first clamping member 110 so that the awning tube 7 is clamped between the first clamping member 110 and the second clamping member 112 as shown in FIG. 30 (with elastomeric layer 124 as shown in FIG. 27 preferably therebetween).

Similarly, line-support arm 21g (FIG. 25), and any other additional line-support arms, are also attached to awning tube 7 and lines 17 are then extended between the line support arms, for example as shown in the previously discussed FIG. 25.

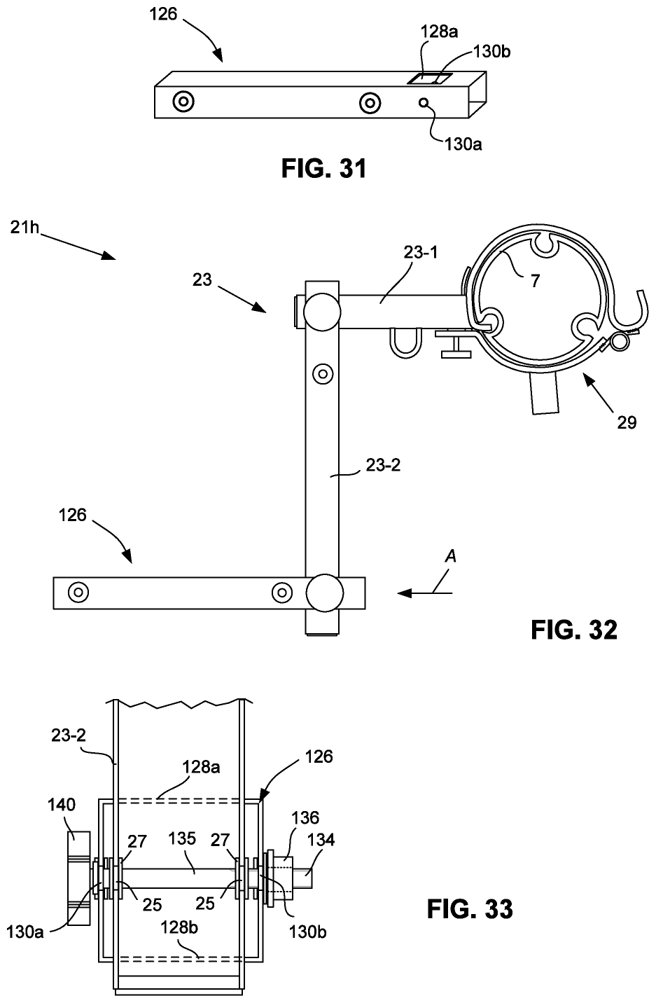

FIG. 31 shows an extension arm 126. Extension arm 126 is formed of rectangular steel section with upper and lower openings 128a, 128b formed therethrough that are sized to allow a lower end of the second elongate member 23-2 to pass through. Depending on the dimensioning of the upper and lower openings 128a, 128b it may be necessary to remove lower bushing 127 from the second elongate member 23-2. Bolt holes 130a, 130b are formed through opposite sides of extension arm 126 for passage of a bolt therethrough. FIG. 32 shows a lower end of the second elongate member 23-2 extending through upper and lower openings 128a, 128b of the extension arm 126. FIG. 33 is an end view of the extension member looking along the direction indicated by arrow 132 in FIG. 33 and with a facing side of the second elongate member 23-2 not shown. It can be seen from FIG. 33 that a bolt 135 (or other suitable elongate fastening member) has been inserted through bolt holes 130a, 130b and through the holes 25 of bushings 27 of the second elongate member 23-2. A point 134 of the bolt is captured by a nut 136. The bolt 135 can be tightened by means of a handle 140 which is rotationally fast with the bolt 135. Consequently, the bolt 135 and upper and lower openings 128a, 128b act to fasten the extension member 126 to the lower elongate member 23-2 at a right angle in the presently described embodiment.

The extension arm 126 is useful where the awning tube 7 is high off the ground relative to the height of a typical user. In that case the line-support arms 21g, 21h may be directed to hang vertically down and then extension arms 126 installed thereto so that the lines 17 run between the extension arm and so are easier for a user to reach.

It will therefore be realized that in one aspect a mobile home clothes drying assembly has been described which comprises a plurality of line-support arms configured to attach to an awning roller tube with one or more lines extendible between adjacent line-support arms of the plurality of line-support arms, for hanging articles to be dried therefrom. Each of the line-support arms includes an elongate portion for supporting the lines and an attachment arrangement extending from an end of the elongate portion and configured to attach to the awning roller tube.

In another aspect a line-support arm for a mobile home clothes drying assembly has been described. The line-support arm is configured to be attached to an awning roller tube and comprises an elongate portion for supporting lines of the mobile home clothes drying assembly an attachment arrangement extending from an end of the elongate portion and configured to attach to the awning roller tube.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. A line-support arm for a mobile home clothes drying assembly configured to be attached to an awning roller tube, the line-support arm comprising:
an elongate portion for supporting lines of the mobile home clothes drying assembly;
an attachment arrangement extending from an end of the elongate portion and configured to attach to the awning roller tube; and
an angular stop member extending away from the elongate portion and dimensioned to be received within a sail track of the awning roller tube.

2. The line-support arm of claim 1, wherein the elongate portion is comprised of a first elongate member and a second elongate member pivotally connected to each other.

3. The line-support arm of claim 1, wherein the attachment arrangement extends from an end of the elongate portion.

4. The line-support arm of claim 1, wherein the attachment arrangement comprises a first clamping member fast with the elongate portion and a second clamping member arranged to cooperate with the first clamping member to clamp the awning tube therebetween.

5. The line-support arm of claim 4, wherein an upper end of the first clamping member is attached to an upper end of the second clamping member by a hinge.

6. The line-support arm of claim 5, wherein an end of the second clamping member remote from the hinge is engageable with the elongate portion for clamping the first and second clamping members about the awning tube.

7. The line-support arm of claim 1, wherein an anti-tilt member is spaced from the attachment arrangement for opposing tilting of the line-support arm in use.

8. The line-support arm of claim 1, including an extension arm formed with openings therethrough for passage of an end of the elongate portion of the line-support arm.

9. The line-support arm of claim 8, wherein the extension arm includes bolt holes for passage of a bolt or other elongate fastening member for fastening of the extension arm to the elongate portion.

10. The line-support arm of claim 4, including a post tube for receiving an end of a post for stabilizing the assembly.

11. The line-support arm of claim 1, including a tether point attached to the elongate portion for attachment of a line thereto.

12. The line-support arm of claim 1, wherein the attachment arrangement includes a hook for attachment of a line thereto;
wherein the attachment arrangement includes a spring member extending from the elongate portion for placement about the awning roller tube to thereby bias the angular stop member toward the awning roller tube;
wherein the spring member is arcuate for placement about a portion of the awning roller tube; and
wherein the angular stop member comprises a tongue that extends from an end of the elongate portion.

13-17. (canceled)

18. The line-support arm of claim 1,
wherein one or more holes are formed through the elongate portion for passage of portions of each of the one or more lines.

19-22. (canceled)

23. The line-support arm of claim 1, including an axial stop for preventing sliding of the first line-support arm and the second line-support arm along the awning roller tube, wherein the axial stop comprises a pin that is fast with the elongate portion for extending into an opening formed in the awning roller tube.

24-26. (canceled)

27. The line-support arm of claim 1, including an extension member for attachment to the elongate portion, wherein an end portion of the extension member is pivotally connectable to the line-support arms by means of a pivot arrangement; and
including a first clamping member fast with the end portion of the extension member and a second clamping member fast with the end portion of the elongate portion of the line-support arm.

28-34. (canceled)

35. A mobile home clothes drying assembly comprising:
a plurality of line-support arms configured to attach to an awning roller tube;
one or more lines extendible between adjacent line-support arms of the plurality of line-support arms, for hanging articles to be dried therefrom,
wherein each of the plurality of line-support arms includes:
an elongate portion for supporting the lines;
an attachment arrangement extending from an end of the elongate portion and configured to attach to the awning roller tube; and
an angular stop member extending away from the elongate portion and dimensioned to be received within a sail track of the awning roller tube.

36. (canceled)

37. The mobile home clothes drying assembly of claim 35, wherein the elongate portion is comprised of a first elongate member and a second elongate member pivotally connected to each other.

38. The mobile home clothes drying assembly of claim 37, wherein the attachment arrangement extends from an end of the elongate portion.

39. The mobile home clothes drying assembly of claim 35, wherein the attachment arrangement comprises a first clamping member fast with the elongate portion and a second clamping member arranged to cooperate with the first clamping member to clamp the awning tube therebetween.

40. The mobile home clothes drying assembly of claim 39, wherein an upper end of the first clamping member is attached to an upper end of the second clamping member by a hinge; and
wherein an end of the second clamping member remote from the hinge is engageable with the elongate portion for clamping the first and second clamping members about the awning tube.
